(19) United States
(12) Patent Application Publication
(10) Pub. No.: US 2006/0117582 A1
(43) Pub. Date: Jun. 8, 2006

(54) Foam-a-shave

(76) Inventor: Hassan Al-Aula, Al Majmaah (SA)

Correspondence Address: HASSAN AL-AULA, PO BOX 109, RIYADH, AL MAJMAAH, 11952, SA

(21) Appl. No.: 11/003,712

(22) Filed: Dec. 6, 2004

(51) Int. Cl. B67B 7/46

(52) U.S. Cl. 30/410

(57) ABSTRACT

The patent being sought for is a gadget of combination built-in foam dispenser and a shaver that discharges foam during shaving. On all the design of the razor in the market, the handle is always left empty. This invention puts the empty handle into good use by using it as a reservoir for storing foam. The foam is stored pressurized and when released apply a shaving foam on the skin intended to be shaved. As the razor is moved in a shaving fashion, the foam is at the same time applied to the skin. Since the discharge of the foam is below the blade, it unsure that the skin is applied with the foam before the blade passes thru.

THE RESERVOIR. The handle of the shaving razor is the reservoir of the gadget. It is made of hard plastic material. It is approximately 6 cubic centimeters in volume. The reservoir contains the pressurized foam ready for application. The bottom of the handle is closed and the top contains the discharge valve where the foam is released. It is assembled with the blade holder as one unit. The upper part of the handle is provided with an opening where the valve could be inserted and it forms a part of the top cover of the reservoir. Insertion of the valve and its actuator is done during fabrication. It is also through this opening that the foam is filled into the reservoir through the same valve. Finally the discharge hose is attached to the mouth of the valve. An opening in the upper back part of the handle is also provided to allow the other end of the discharge hose to be connected to the nozzle. The nozzle is slid lock into the window of the blade assembly.

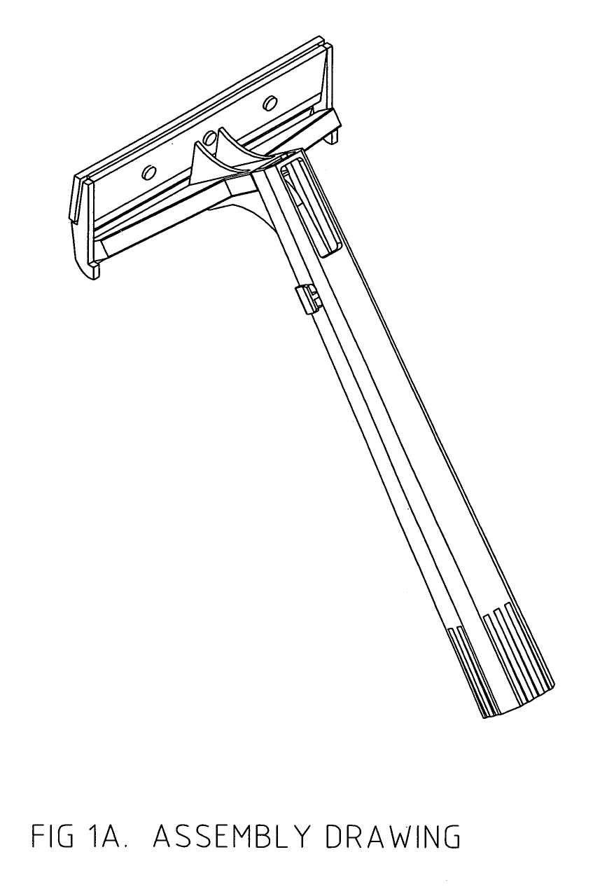

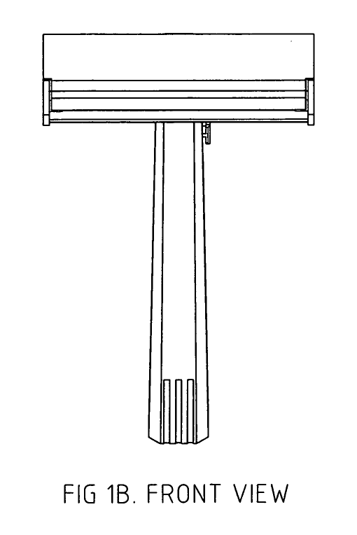

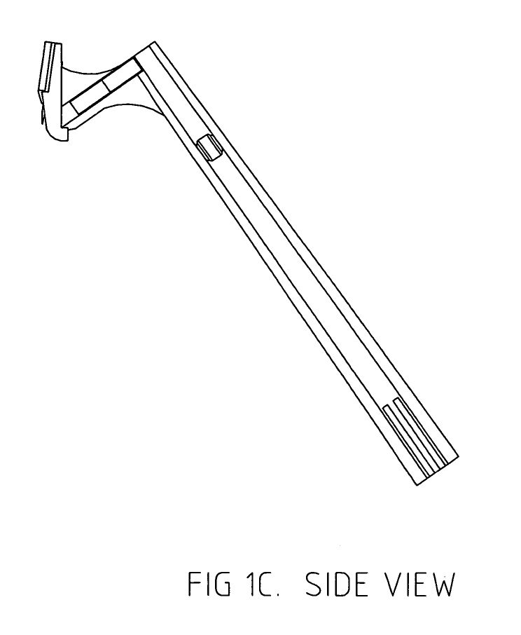

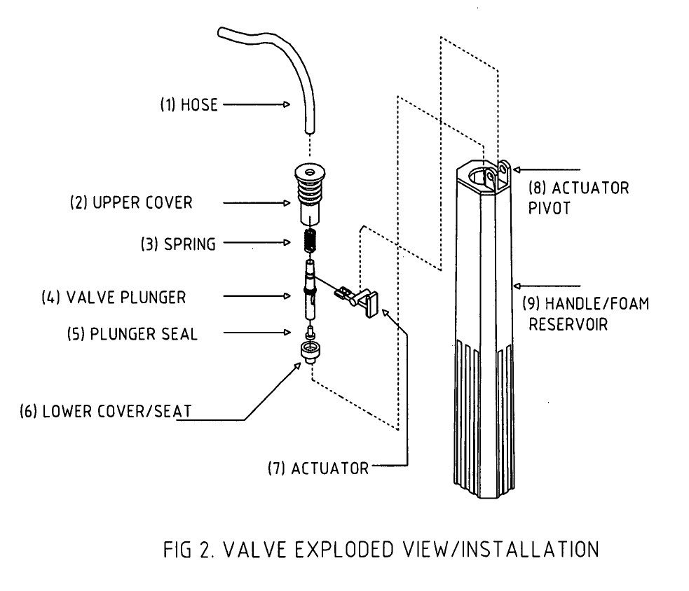

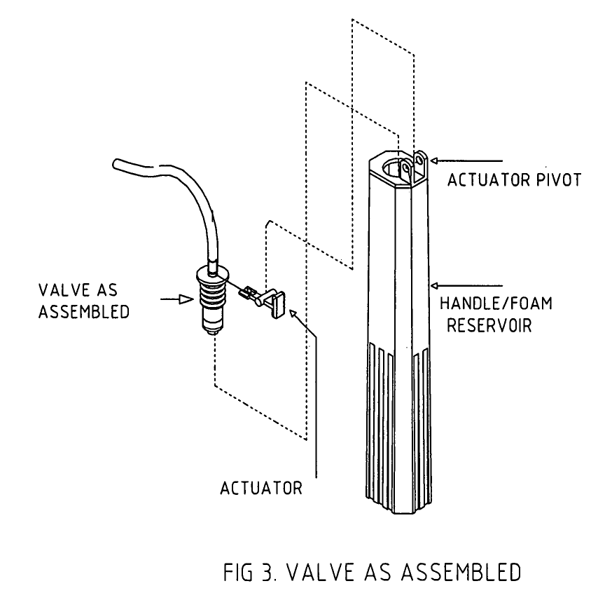

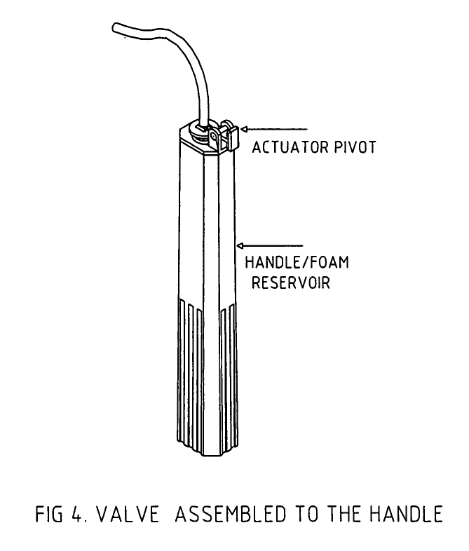

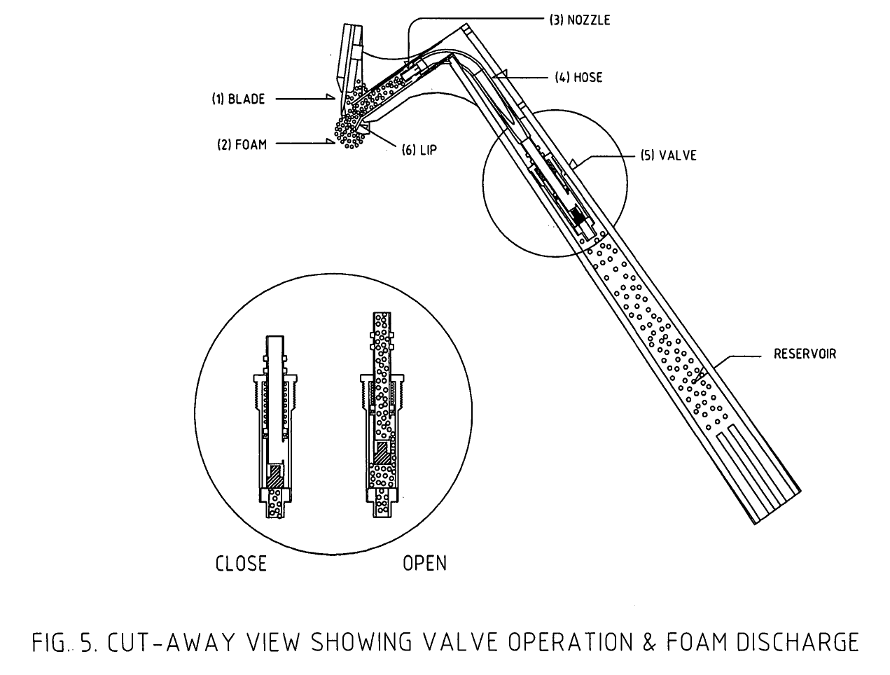

DISCHARGE VALVE. The discharge valve contains the following parts namely: (1) hose, (2) upper cover, (3) spring, (4) valve plunger, (5) plunger seal, (6) lower cover/seat and (7) actuator. FIG. 2 shows the internal parts and FIG. 3 shows the valve as one unit. Functional description is as follows.
a. As the actuator (7) handle is pushed downward, it moves thru the pivot (8) causing its opposite ends to move upward pulling with it the plunger (4). The plunger opened releasing foam from the reservoir (9) via the lower/seat (6). The foam then passes inside the valve and into the discharge hose (1) and the nozzle ((3) of FIG. 5).
b. When no foam is needed, the actuator (7) is released. The spring (3) returned the valve plunger (7) and the seal (5) back to the lower cover (6) stopping the foam discharge. The foam is continually released as long as the actuator is held downward.
c. The valve is assembled in to the handle during fabrication and the corrugated portion of the upper cover keeps it in place ensuring integrity even when pressurized. Please refer to FIGS. 3 & 4.

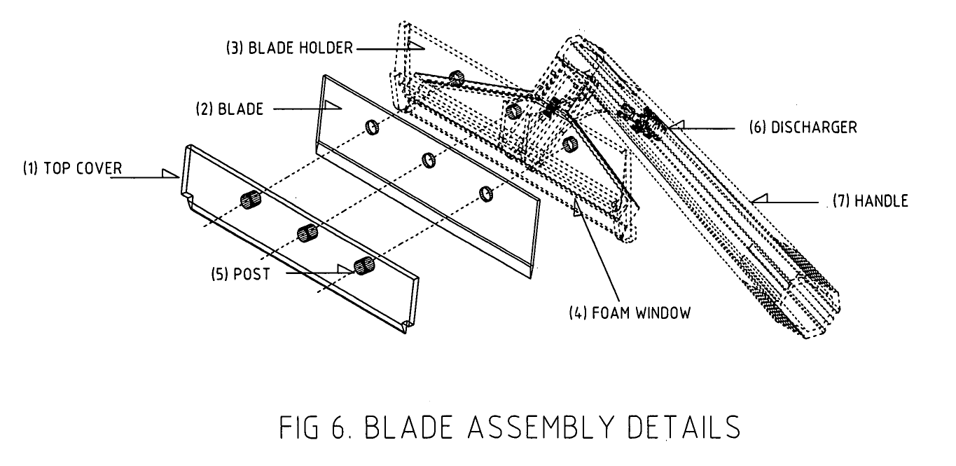

BLADE ASSEMBLY. Please refer to FIG. 5. The foam is released through the nozzle (3) located in the neck of the foam window ((4) of FIG. 6). The foam window is shaped in such a way that it is small from the nozzle and enlarges to the size of the blade width. This shape ensures the dispersal of the foam on the entire length of the blade. The lip which is in contact with the skin ensures the foam application. It also ensures that the shaved hair and the spent foam are removed through the gap between the foam window and the blade. The lip (6) also seals the area of application ensuring that the pressurized foam would not be released except on the upper gap between the blade and the window. Combined with the pressure of the foam and the downward movement while shaving, shaved hair and the spent foam are also disposed.

1. I put a claim on the idea of a disposable shaving razor with built-in foam dispenser. Included in my claim is the idea where the foam could be stored under pressure, the mechanism for its release from its container and finally its application on the skin. Also included in the claim is the design of the following
1. The discharge valve its component parts and function.
2. The design of the blade assembly and the relative function of the individual component parts to achieve the desired function and its relation with the other parts.
